(19) United States
(12) Patent Application Publication
(10) Pub. No.: US 2026/0000996 A1
(43) Pub. Date: Jan. 1, 2026

(54) HISTORICAL PLAYTHROUGH FOR ASYNCHRONOUS EVENTS

(71) Applicant: AviaGames, Inc., San Mateo, CA (US)

(72) Inventors: Tian Zeng, Beijing (CN); Jiangbo Tian, Beijing (CN); Junhan Wu, Shanghai (CN); Shengwen Yang, Beijing (CN); Peng Zhang, Beijing (CN); Haotian Kuang, Beijing (CN)

(73) Assignee: AviaGames, Inc., San Mateo, CA (US)

(21) Appl. No.: 19/196,630

(22) Filed: May 1, 2025

Related U.S. Application Data
(60) Provisional application No. 63/666,582, filed on Jul. 1, 2024.

(51) Int. Cl. A63F 13/798; A63F 13/795

(52) U.S. Cl. CPC A63F 13/798; A63F 13/795

(57) ABSTRACT

Disclosed subject matter including methods, computer systems, and computer-readable media for selecting users to pair for a real-time user of interactive online applications, including skill-based video games. In some examples, when there are not enough other real-time users to pair with the real time user, the real-time user can be paired with a simulated user based on historical playthrough data generated by a prior game session with another user. Various techniques for assessing skill level of users, providing a historical playthrough experience for the real-time user, and selecting game content based on historical records selected based on comparing skill of the real-time user and other real time or historical playthrough users are disclosed. Data structures and techniques for efficiently identifying comparable historical records based on the assessed skill of the real-time user are disclosed.

### CROSS-REFERENCE TO RELATED APPLICATIONS

This application claims the benefit of U.S. Provisional Application No. 63/666,582, filed Jul. 1, 2024, which application is incorporated herein by reference in its entirety.

### BACKGROUND

Online gaming between human players remains popular across different types of games player across the world. In some cases, it can be difficult to identify players for a game that are available to play a game at the same time, at similar skill levels, and/or in the same regions available to participate in the game. Accordingly, there is ample opportunity for improvement in game experiences provided to players of competitive networked computer games.

### SUMMARY

Methods, apparatus, and computer-readable storage devices are disclosed for managing users interacting with computing devices via asynchronous events. In some examples of the disclosed technology, historical playthrough is used to provide competition in an online, computer-implemented game between one or more currently logged-in, live players and the recorded gameplay of one or more historical players who previously played the same game as logged-in, live players (i.e., prior to the currently logged-in, live players). The computer-generated players use game data generated by previous playthroughs of a competitive game that is at least partially recorded and played back to provide a simulation of real-time competition with the one or more human players. The game data for the computer-generated players can be selected using any of the techniques disclosed herein. A skill level is assigned to the computer-generated players and the human players to facilitate competitive play and provide fair competition.

Examples of the disclosed technology include systems, methods, and computer-readable media for dynamically pairing players in competitive online games using assessments of both real-time and historical player performance. These examples of the disclosed technology can include computer-readable instructions stored on computer-readable media that, when executed by a processor, configure the processor to perform operations such as evaluating user skill, selecting opponents, and distributing game content for synchronous or asynchronous gameplay.

In some examples of the disclosed technology, a system can include a processor, a network interface, and computer-readable storage media storing computer-executable instructions. The processor can be configured to generate a real-time user rating by ranking a game outcome of a real-time user relative to outcomes from previously played matches by other users under similar or identical game initiation conditions. Based on this rating and game data of other users, the processor can pair the real-time user with at least one other user, including a live user or a historical playthrough user, and initiate a match between the users.

Game content can be provided to the real-time user based on actions or outcomes generated by the paired user. In some examples, for a historical playthrough user, this content can be based on outcomes produced in a previous session. For a live user, the content can reflect actions or outcomes generated concurrently during live gameplay.

The processor can also be configured to generate a rating for the other user by ranking prior game outcomes relative to those of other users under similar conditions, and to use the comparison between the real-time user rating and the other user's rating to support the pairing process.

In some examples involving competitive online games, the system can be configured to generate a base skill rating and a high skill rating for each player. These ratings can be based on factors such as the player's rating prior to the match, actual or expected outcomes of the match, predetermined adjustment factors, the skill level of opponents, or other suitable factors. Either rating can also be based on percentile rankings of historical outcomes. In some examples, the processor can be configured to combine these ratings using a segmented skill assessment approach, including nonlinear weighting, to produce a refined user rating for use in matching players.

In certain examples, both the real-time user and the paired user can participate in the same match using at least partially identical game content, where the content is generated using a common random seed or shared starting conditions associated with a designed level. The system can also be configured to perform a segmented assessment of skill level for the real-time user, a live user, or a historical playthrough user, by combining a base rating and a high-ability rating. The base rating can be generated by determining a percentile rank of one or more game outcomes, and the high-ability rating can reflect whether a game outcome exceeds a predetermined threshold. In some examples, a final user rating used for pairing can be based on a nonlinear combination of the base and high-ability ratings.

Some examples of the disclosed technology can include functionality for accessing a cache of user records or leaderboard data. The processor can be configured to identify a record based on a key index and a range of player ratings, and select one or more users based on the identified data. In some cases, the key index is based on a seed used to generate the game content, such that using the same seed results in the same content and different seeds yield different content.

Some examples of the disclosed technology include methods implemented with a device comprising a processor, a user input control, a display, and a network interface. In some examples, the processor can be configured to invoke an application to provide an online game session to a real-time user. Based on input from the user control, the device can send a signal indicating at least one game parameter to an online game server. The online game server can be used to calculate a skill level for the real-time user and, based on the skill level, the parameter, or both, select a historical playthrough opponent. The server can be used to generate game content based on a game outcome produced by the selected opponent in a prior match, and this content can be transmitted to the device. The processor can cause the device to present a game experience to the real-time user using the received content via the display and user input control.

In some examples, the application can present an interface allowing the user to select a game from a plurality of games. The selected game can be identified in a signal transmitted to the server, and the game content can be generated in response. The processor can also be configured to receive an indicator of an entry fee from a digital wallet associated with the user, and based on the outcome of the match, either distribute a prize to the wallet or transfer the entry fee to another account.

In some examples, the game experience can include head-to-head gameplay against another live player or asynchronous play using outcomes generated by a historical playthrough user.

Some examples of the disclosed technology include computer-readable media storing instructions that, when executed, cause the processor to determine a skill-based bucket of historical gameplay records from a database. The processor can be configured to retrieve one or more records from the bucket and use these to initiate an online match involving the real-time user and a historical playthrough user. Selection of records can be based on various factors including game identifiers, content-generation seeds, bucket identifiers, and record position within the bucket.

In some examples, the processor can be configured to host the match and generate a new historical record for future use. These records can include structured data such as one or more of: a game identifier, seed, rating bucket identifier, record ID, gameplay history, and a unique key derived from these elements. This data structure can enable systems to efficiently match players and improve replayability of curated or competitive game scenarios.

This Summary is provided to introduce a selection of concepts in a simplified form that are further described below in the Detailed Description. This Summary is not intended to identify key aspects or essential features of the claimed subject matter, nor is it intended to be used to limit the scope of the claimed subject matter. The foregoing and other objects, aspects, and advantages of the disclosed subject matter will become more apparent from the following detailed description, which proceeds with reference to the accompanying figures.

### BRIEF DESCRIPTION OF THE DRAWINGS

FIG. 1 is a block diagram outlining an example networked computing environment in which certain examples of the disclosed technology can be implemented.

FIG. 2 is a pair of charts depicting calculation of player performance or skill level, as can be implemented in some examples of the disclosed technology.

FIG. 3 is a flow chart outlining an example method for calculating skill levels, as can be implemented in certain examples of the disclosed technology.

FIG. 4 is a flow chart outlining an example of producing a player user rating using a historical score list, as can be implemented in certain examples of the disclosed technology.

FIG. 5 is a flow chart outlining a method of finding historical records, as can be implemented in certain examples of the disclosed technology

FIGS. 6A-6B depict a flow chart outlining an example player matching process, as can be implemented in certain examples of the disclosed technology.

FIG. 7 is a diagram outlining an example of historical playthrough as can be implemented in certain examples of the disclosed technology.

FIG. 8 is a flow chart outlining an example method of providing an online game including a historical playthrough opponent, as can be implemented in certain examples of the disclosed technology.

FIG. 9 is a diagram further illustrating an example method of providing an online game including a historical playthrough opponent, as can be implemented in certain examples of the disclosed technology.

FIG. 10 depicts a generalized example of a suitable computing system in which embodiments, techniques, and technologies can be implemented.

### DETAILED DESCRIPTION

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” “initiate,” “launch,” and “invoke” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, C#, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### I. Introduction to the Disclosed Technology

Methods, apparatus, and computer-readable storage devices are disclosed for managing users interacting with computing devices via asynchronous events. Players can be rated or have a skill level assigned to facilitate competitive play and fair competition. In some examples of the disclosed technology, historical playthrough is used to provide competition in an online, computer-implemented game between one or more “live” players, who are currently logged-in and participating in an online game and one or more asynchronous or “historical playthrough” players, who compete with the live players through the use of recorded gameplay of one or more players who previously played the same game as logged-in, live players. In other words, the historical playthrough players have completed a game match prior to the currently logged-in, live players playing the online game. Online gameplay with historical playthrough players can be provided using game data generated by previous playthroughs of a competitive session using the same game content. In some examples, game data is at least partially recorded and played back to provide a simulation of live competition to one or more currently logged-in players. In other examples, game outcome data such as scores, milestones, or badges are provided. Game outcome data may be generated for live players and stored for a historical playthrough player to be provided to a game session for a live user.

At least some of the game content provided to the current, live players is the same as the game content that was provided to the historical playthrough players. For example, some online games use a seed, for example, a random or pseudo-random number or set of numbers, to generate game content. The game content is varied according to a particular seed. For example, the order of cards for an entire deck of cards for a solitaire game can generated from a seed. In some examples, data such as time or date stamps can be used as a portion or all of a seed. By using a seed, live players can be provided with a game experience consistent to that provided to the prior historical playthrough players. Accordingly, ratings or comparisons of player attributes will tend to be more accurate, because the performance of players is compared under similar game conditions generated from the same seed. Thus, the live players and historical playthrough players will each play under the same game setup parameters as every other player in a competitive match. Additionally, using seeds can improve replayability of the game, because players experience different game conditions for subsequent matches of the same game, and hence player engagement can be improved. In other examples, live players can be provided with “designed levels,” where the same content for a particular level of the game, including detailed information about starting conditions, are provided. As an example, the placement and motion of game objects can be specified and provided to live and historical playthrough players, allowing players to be evaluated under similar or identical game conditions. As another example, starting conditions for a puzzle game can be provided that have been designed to provide for engaging game play for a particular match.

The use of historical playthrough players can be contrasted with the use of so-called “bots,” which are artificial intelligence (AI) or other software players that have been programmed with the rules of the game and can mimic against a live player. Game actions taken by the bots are determined by their programming, and thus do not reflect the same game outcomes realized from recording game actions taken by prior live players. Thus, game actions and outcomes generated from historical playthrough players will reflect gameplay as taken by real, live players, not artificial bots or other such programs.

Therefore, it will be readily understood to a person of ordinary skill in the art having the benefit of the present disclosure that the foregoing and other specific techniques disclosed herein, when deployed in the example and other suitable computer environments described herein, provide technical effects not realized in generic or conventional computing environments. Such technical effects include but are not limited to those provided by the innovations disclosed herein, including technologies for player skill assessment, player pairing, historical playthrough, content generation, and modified gameplay that in certain examples can improve computer system performance and resource usage, as well as improved replayability and player engagement.

### II. Example Networked Computing Environment

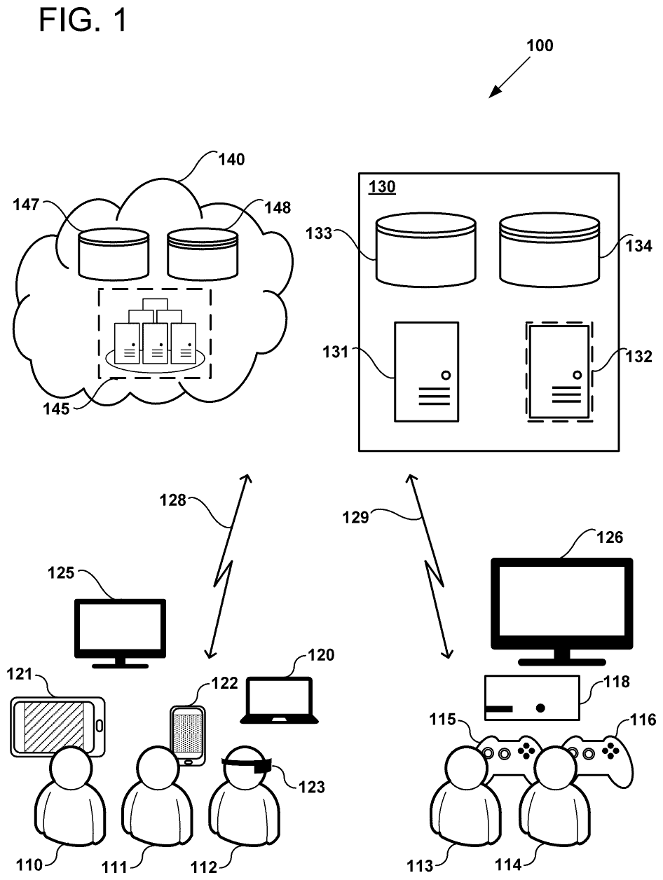

FIG. 1 is a block diagram 100 outlining an example networked computing environment in which certain examples of the disclosed technology can be implemented. For example, disclosed methods for displaying a game content including the use of interactive controls that can be used to browse combined application-specific and aggregated statistics for users and to launch applications can be implemented in the environment of FIG. 1. Further, the environment can support an application hub system that provides user interface controls for invoking a selected application of a plurality of two or more applications.

As shown in FIG. 1, a number of application users 110-114 are using a number of different computing devices to the networked computer environment. Examples of suitable computing devices include, but are not limited to, a laptop computer 120, a tablet computer 121, smartphone 122, and virtual reality or augmented reality headwear 123. In some examples, some of the computing devices can be coupled to a display 125 or 126, and in some examples the displays themselves include smart TV functionality which allows for performing some of the disclosed methods. Three of the users 110-112 shown are currently located at the same location and their computing devices can communicate with each other using, for example, a local area network (LAN). Two other users 113 and 114 are currently at a different location from the first three users. Each of these users 113 and 114 is using a game controller 115 or 116 respectively to provide input to a gaming console 118, another example of a computing device. Both the first computing devices at the first location and the gaming consoles can be connected to a wider area computer network, for example the internet, using network connections 128 and 129 implemented with a suitable computer networking technology. Computing resources that can be accessed in the Internet include a dedicated networked server 130, which can include one or more of: a server computer 131, a virtual server 132, a storage 133, and/or a database 134. At least one of database 134 can be a historical playthrough database. Further, the computing devices, including the gaming console 118, can alternatively be connected to computing resources located in a computing cloud 140. The computing cloud 140 includes an array of virtual servers 145 that can be provisioned on demand in order to provide functionality for performing certain disclosed methods. The computer cloud also hosts on-demand storage 147 and databases 148 that can be used to implement certain disclosed methods.

In some examples, a method of displaying an interactive control with a contextual interface includes providing an interactive control to browse data for an individual application along with aggregate statistics that are collected at two or more locations.

Information for the interactive control can be generated at one or more of the following locations: at any of the computing devices, at the gaming console 118, at the server 130, or within the computing cloud 140. These systems can also be used to provide disclosed methods of accessing and launching applications, for example by allowing a user to browse data indicating credibility and other aspects of a number of users and select one of the users to join in multi-player game session or other multi-user application.

In some examples, some or all of these components are used to form an application hub system that provides user interface controls for invoking a plurality of applications. The application hub system can include an entity browser component configured to generate display data for a selected portion of credibility data for one or more entities, a configuration component that is configured to select a subset of credibility data for display by the entity browser component, and/or an application invocation component that is configured to launch a selected one of the plurality of applications. In some examples, the entity browser component can be used to browse users of one or more applications, such as games. In other examples, other entities are browsed instead of or in addition to users (e.g., organizations, teams, or other entities). The selected application can be selected using the interface control that is provided by the application hub system. In some examples, computer executable instructions for implementing the application hub system are located remotely, for example at the server 130 or in the computing cloud 140. In other examples, some or all of the computer executable instructions used to implement the application hub system are located on one or more of the computing devices, for example, the gaming console 118.

As will be readily understood by one of ordinary skill in the relevant art, a variety of communication technologies can be used to connect the components depicted in FIG. 1 including, for example the internet, intranets, cable, including fiber optic technologies, magnetic communication, electromagnetic communication, including RF, microwave, and infrared communications or other suitable communication technologies.

### III. Example Player Matching Based on Skill Level

In competitive games, human skill levels vary. If players with significant differences in skill levels are matched together, it will inevitably affect the fairness of the game and the players' competitive experience: players with relatively lower skill levels will feel frustrated and unfairly matched, while players with relatively higher skill levels will feel insufficiently challenged. Therefore, there is ample opportunity for improvement in accurately assessing players' skill levels and matching them accordingly is crucial for competitive games. In some situations, there are not enough real-time human players in a desired skill level range to present a fair and competitive real-time game. In such cases, historical playthrough can be used to present stored actions and/or results from previously played games to simulate real-time head-to-head competition, or to provide asynchronous play in competition with the previously played game (for example, by comparing scores reached under identical starting conditions).

In competitive games, known skill level assessment algorithms like ELO and Glicko have drawbacks such as slow convergence and high fluctuation due to the influence of game content and opponents. If an opponent with fast and stable skill level convergence can be found, it will enable accurate assessment of players' skill levels. It may be desirable in some such instances that such an opponent be able to quickly accumulate a sufficient number of match records.

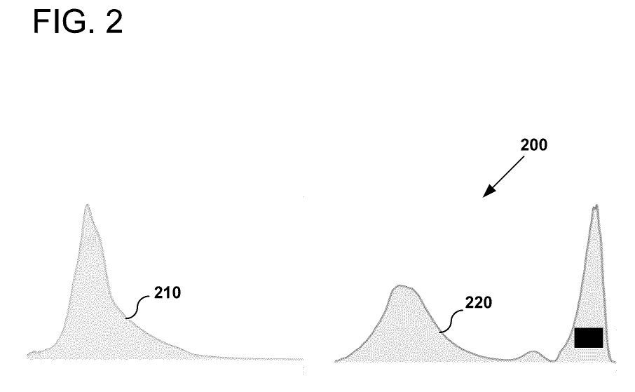

In competitive games, players in the same match generally play the same game content. The game content may be generated by random seeds or designed levels, which provides a similar or identical game setup to different players. Based on the number of possible starting conditions and the number of matches provided for an online game, it can be challenging to provide a fair and accurate pairing of players. Consider a competitive online game where human player P is competing against a Player S as the opponent. ELO can be used to calculate the player's skill level. FIG. 2 is a pair of charts 200 depicting calculation of player performance or skill level, as can be implemented in some examples of the disclosed technology. However, ELO is an approximate algorithm based on an assumption of a normal distribution (as shown in the left FIG. 210). However, when the game content has some difficulty thresholds, the players' performance may not follow a normal distribution but rather a Gaussian mixture distribution (as shown in the right FIG. 220). Thus, relying solely on ELO can make it difficult to accurately assess the players' skill levels.

In some examples, a segmented assessment of player skill is employed. For example, the basic skills of all players can be referred to as base ability (base_rating) or base skill level, and the ability of players to surpass thresholds can be referred to as high-scoring ability (high_rating) or high skill level.

As one example, the iteration of skill level segmented values may be determined according to the following equations:

$$E = \frac{1}{1 + {10}^{( \frac{{R}_{p} - {R}_{o}}{400} )}} \qquad ( Eq . 1 )$$

$${R}_{n} = {R}_{o} + K \times ( S - E ) \qquad ( Eq . 2 )$$

### Where in Equation 1:

E—is a number representing an expected result of the match, which is determined using:
Rₚ—is a number representing the opponent's rating, and
Rₒ—is a number representing the player's old rating (prior to the match)
   After a match, the player's new rating can be determined using Equation 2, where
Rₙ—is the player's new rating (after the match).
Rₒ—Represents the player's old rating (before the match).
S—is a number representing the actual result of the match. For example, S can correspond to a percentile rank over previous match results.
E—is a number representing the expected result of the match, which can be calculated using Equation 1.
K—is number representing a factor, termed “K-factor.” The K-factor is multiplied by the difference between the actual result and the expected result and combined with the old player rating Rₒ to determine the new player rating Rₙ. The K-factor can be adjusted to increase or decrease the impact of deviations in match results on the player rating.

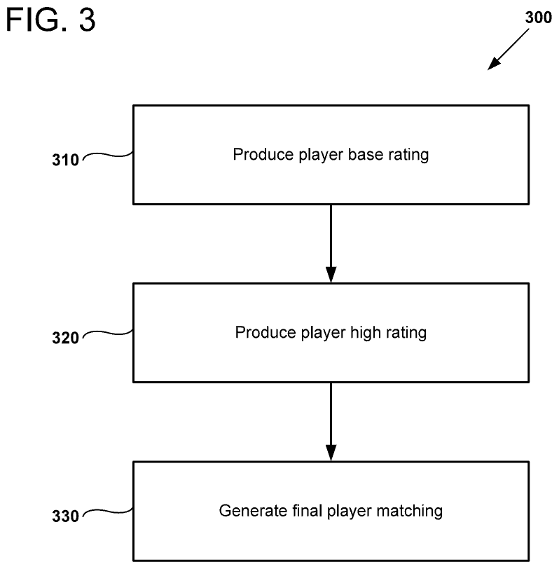

FIG. 3 is a flow chart 300 outlining an example method for calculating skill levels as can be implemented in certain examples of the disclosed technology, including the example networked computing environment discussed above regarding FIG. 1. A system for using computer-implemented applications can be used to facilitate pairing of at least one real-time user with at least one other user, the at least one other user being another real-time user or a historical playthrough user for a computer-implemented application providing interaction between the paired users. In other words, a subject real-time user can be paired with one or more other real-time users, with one or more historical playthrough users, or with a combination of the two types of players. The historical playthrough user is used to simulate the actions of a real-time user in the application when paired with the real-time user, using history data previously generated by a user while using the application. For example, in the case of a online gameplay, data for the historical playthrough user is collected and can be played back or otherwise used to simulate real-time interactions at a later point in time. As a further detailed example, the historical playthrough user can play a solitaire card game, and the arrangement of cards in the deck, the moves made by the user, and/or scoring data can be collected and stored. Later, the application can simulate competition with the real-time user by providing the same arrangement of cards in the deck, reproducing moves made by the historical playthrough user, and or comparing scoring data with the real-time user.

At process block 310, a player base rating is produced using a player skill relation, such as the one introduced above in Equations 1 and 2. For example, a computer system can be used to assess skill level of the at least one real-time user, thereby producing a real-time user rating. Further, a computer system can be used to assess skill level of at least one other historical playthrough user by evaluating history for the prior gameplay of the historical playthrough user, thereby producing at least one other user rating. In some examples, the base skill level can be produced using at least one of: a player's rating before a current match of the competitive online game, an actual result of a match of the competitive online game, an expected result of a match of the competitive online game, a predetermined factor, player reaction time, speed in accomplishing in-game tasks, or a skill rating of an opponent. In some examples, the base skill level is produced using a percentile rank of historical records for prior matches of the competitive online game.

To make the results more convergent, the player's score percentile ranking in all historical records of the game as the actual result S. For example, if the player ranks in the 90th percentile, then S is 0.9. In this case, when calculating a player's base rating, the player's rank can be set as the complement of S, 1−0.9, which is 0.1. The historical records or scores achieved by two players under a particular seed may be different. In some examples, the historical records or scores can be ranked, and each rank corresponds to a percentile. For example, if the historical scores range from 1 to 200, a score of 200 corresponds to the top 0.5 percentile.

At process block 320, a player high rating is produced using a player skill relation, such as the one introduced above: Using a concept from classification algorithms, if the player's score exceeds a certain difficulty threshold, it is considered that the player has the ability to achieve high scores, and HS is set to 1; otherwise, HS is set to 0. In some examples, the system can produce the high skill level using at least one of: a player's rating before a current match of the competitive online game, an actual result of a match of the competitive online game, an expected result of a match of the competitive online game, a predetermined factor, player reaction time, speed in performing in-game tasks, or a skill rating of an opponent. In some examples, the high skill level is produced using a percentile rank of historical records for prior matches of the competitive online game. As an example of applying a classification algorithm, consider a game where players are roughly divided into two categories based on their gaming ability and behavior. One category of players understands how to use special game items provided by the game that can significantly boost a player's score, while the other category of players does not use such game items at all. In the example game, generally only players who know how to use game items can achieve high scores. Thus, the players' skill levels can be determined based on this characteristic (use of particular game elements) and players categorized into one category or the other accordingly. In some examples, the player high rating can be set to a number of different values in a range. In some examples, the system can assess the skill level of the at least one real-time user, the at least one other user or the at least one other and the another real-time user or historical playthrough user, based on a segmented assessment combining a base rating and high-ability rating for each respective assessed user. In some examples, the system can generate a user rating based on a nonlinear weighting of the base rating and the high-ability rating. In some examples, the system can generate the high-ability rating by assessing whether a game outcome for the respective assessed user exceeds a pre-determined threshold.

At process block 330, a final player matching or pairing is generated. In some examples, the skill level user rating is a nonlinear weighted combination of base rating and high rating. For example, by comparing player base ratings, player high ratings, or the base and high ratings in combination, to select two or more paired users. For example, a real-time user can be paired with another one or more real-time users, another one or more historical playthrough users, or a combination of real-time and historical playthrough users. The paired two or more users can be selected to participate in an application, including competitive online computer games such as head-to-head or asynchronous competitions. In some examples, the system hosts a match of a competitive online game including the real-time player and the selected paired at least one other user. In some examples, the paired players each play in the same match using at least some of the same game content, the game content being generated using at least one seed. In some examples, the game content is provided as a designed level including detailed information about starting conditions. In some examples, some game content can be provided to the real-time user during the match based on game actions or game outcomes that were generated by the paired at least one other user prior to the system initiating the match. In some examples, some game content can be provided to the real-time user during the match based on game actions or game outcomes concurrently generated by at least one other user or player during the match.

### IV. Example Generation of Player Ratings

In competitive games, human skill levels vary based on player experience with games in general, with experience with a particular game, effort, or other factors. If players with significant differences in skill levels are matched, then the game can feel unfair to less skilled players, and more skilled players may be disinterested from the lack of competition. Accordingly, in head-to-head synchronous play or asynchronous play, user interest may be maintained longer by pairing participants in a particular match based on a rating of player skill. In some examples, a real-time player can be paired with other real-time or historical playthrough players having comparable skill levels. The range of ratings for other players paired with a real-time player, whether pairing live or historical playthrough players, should be selected so that the real-time player has a fair and engaging in-game experience.

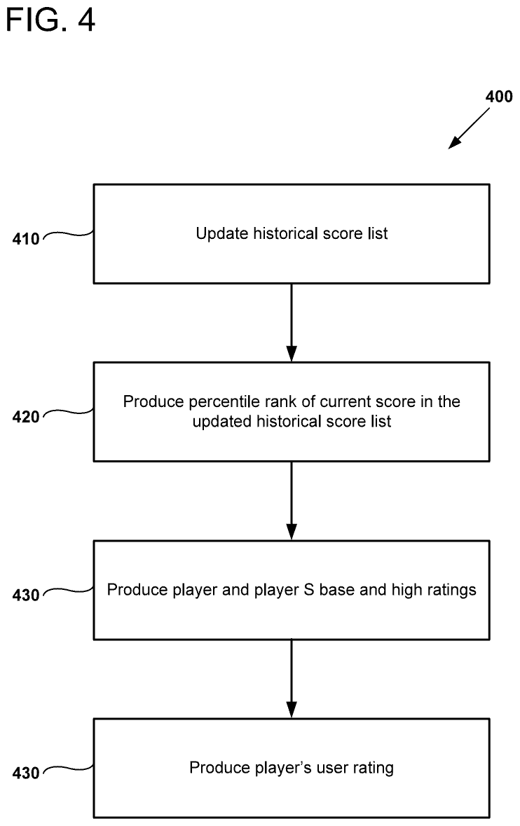

FIG. 4 is a flow chart 400 outlining an example of producing a player user rating using a historical score list, as can be implemented in certain examples of the disclosed technology, including the example networked computing environment discussed above regarding FIG. 1.

At process block 410, a player score is received from completing a match and a historical score list is updated. In some examples, a sorted list of scores is maintained, and the player score received for the most recent match is inserted into the list.

At process block 420, a percentile rank Sₒ of the current score is produced using the updated historical score list. For example, the historical score list can be bisected according to the score for the most recent match to determine the position of the current score in the list, and to convert the position to a percentile based on the number of scores stored in the score list. As will be readily understood to a person of ordinary skill in the art having the benefit of the present disclosure, other techniques can be used to produce a percentile rank for the current score or other statistical ranking suitable for assessing player skill against a collection of historical game outcomes.

At process block 430, high-scoring ability, base and high player ratings are produced for the current player and for a generic skilled player S relating to the same game content. For example, a player's high scoring ability can be determined by any appropriate technique. For example, if a player exhibits the use of certain high-skill techniques during game play, the player can be indicated to have a high scoring ability. In some examples, the player is designated to have high scoring ability if one or more matches result in a score exceeding a threshold, or if a certain of level of play is achieved in a game.

The player's base rating Rₒ and high rating HRₒ, as well as Player S's base rating Rₚ and high rating HRₚ, can be produced using Equations 1 and 2 with the respective values for the players. The percentile rank produced at process block 420 provides the value Sₒ used in Equation 2. The player's user rating can then be determined using Equation 3:

$${R}_{u} = H {R}_{o} + ( {R}_{o} - H {R}_{o} ) \times \frac{1}{1 + {10}^{( \frac{1500 - H {R}_{o}}{400} )}} \qquad ( Eq . 3 )$$

Pseudocode presented using the Python language is presented in Table 1 below for an example implementation of player rating and matching using ELO. Computer-readable instructions can be executed by a processor to implement the operations specified by the pseudocode in this example and the other code examples below. For example, a player pairing unit can use computer-executable instructions to perform operations specified by the pseudocode examples below.

TABLE 1

```
:param S: Actual result of the player
:param Ro: Current skill level of the player
:param Rp: Current skill level of the opponent
:param K: factor (default 64)
:return: new rating
def elo(S, Ro, Rp, K=64):
    E = 1 / (1 + 10 ** ((Rp − Ro) / 400))
    return Ro + K * (S − E)
  ### After a player completes a match, iterate to update the
player's skill level and the skill level of Player S
corresponding to the game content.
:param score: Player's match score
:param Ro: Player's base_rating
:param Rp: Player S's base_rating
:param HRo: Player's high_rating
:param HRp: Player S's high_rating
:param score_history_sorted_list: Sorted list of all scores
obtained by all players for that game content
:return: Player's new base_rating, Player's new high_rating,
Player's new user_rating, Player S's base_rating, Player S's
high_rating
def iterate_rating(score, Ro, Rp, HRo, HRp,
score_history_sorted_list):
    # Update and sort the historical score list
    bisect.insort(score_history_sorted_list, score)
    # Get the rank of this score in the historical list
    rank = bisect.bisect_left(score_history_sorted_list,
score)
    # Calculate the percentile rank of the score as the
player's S
    So = rank / len(score_history_sorted_list)
    # S for Player S
    Sp = 1 − So
    # S for the player's high-scoring ability
    HSo = 1 if score > THRESHOLD_SCORE else 0
    # S for Player S's high-scoring ability
    HSp = 1 − HSo
    # Calculate the player's base_rating
    Ro = elo(So, Ro, Rp)
    # Calculate the player's high_rating
    HRo = elo(HSo, HRo, HRp)
    # Calculate Player S's base_rating
    Rp = elo(Sp, Rp, Ro)
    # Calculate Player S's high_rating
    HRp = elo(HSp, HRp, HRo)
    # Calculate the player's user_rating
    user_rating = HRo + (1 / (1 + 10 ** ((1500 − HRo) /
400))) * (Ro − HRo)
    return Ro, HRo, user_rating, Rp, HRp
```

After assessing the player's skill level, pairing (matching) can be done according to the player's skill level; while matching, look for players waiting to be matched who have similar skill levels (within a delta deviation) under the same game and the same match content (generated from the same seed or the same designed level). As used herein, “pairing” includes matching of two, or more players, for a match. Because the number of players waiting to be matched online at the same time may be relatively limited, a leaderboard cache can be used to assist in matching and using the player's skill level as the sorting condition. for example, the zset commands of the publicly-available Redis database package can be used with a sorted set of a collection of members ordered by an associated score:

TABLE 2

{
“key”: “for game:seed”,
“score”: “is the player's rating”,
“member”: “is the player waiting to be matched or the match
created by the player”
}

In the example of table 2, a data structure stores a key (here, a seed used to generate game content, a score representing the assessed skill of a player, and member indicating whether the player is waiting for a match or if the player created a match.

As one example, if there is a player A to be matched and his skill level is ratingA, then the zset function zrangebyscore can be used to find the opponent, as shown by the code in Table 3:

TABLE 3

zrangebyscore game:seed, ratingA−delta, ratingA+delta]

In further detail, the system can identify a user record stored in a leaderboard cache, the leaderboard cache storing game outcome records for the at least one other user, the user record being identified in the leaderboard cache according to a key index and a range of player ratings, and select at least one of the paired users as a user associated with the identified user record. In some examples, the key index is based on a seed used to generate content for application, wherein the same content is generated for the application when the same seed is used to generate content, and different content is generated for the application when a different seed is used to generate content.

The number of online players may be limited, and the number of online players with similar skill levels may be even smaller. This can result in players waiting a long time to match with players of similar skill levels, leading to a poor matching experience. To improve the matching experience, for asynchronous games, historical records of other players who played the same game content at a similar skill level can be used for matching. However, for some games, the number of historical records can be enormous, potentially reaching tens of billions. The performance of filtering these historical records can also impact the matching experience.

As an example, at a point in time there may be many live players of differing skill levels currently waiting for a match for a particular online game. To quickly match players (e.g., to quickly find live or historical playthrough players with similar skill levels for a match), the current players waiting to be matched are sorted based on their skill levels. As an illustrative example, consider a situation where Player A has a skill level of 2100, Player B has a skill level of 2200, and Player C has a skill level of 2300. By doing this, players with similar skill levels (e.g., that have skill levels close in ranking) can be quickly identified and matched with each other. This method is more efficient than comparing players one by one randomly and then deciding whether to match them.

In some examples, historical records can be stored in a relational database. An example of using a corresponding data structure for a history record is illustrated by the code shown in Table 4:

TABLE 4

```
history_record
{
  game, // the game played
  seed, // if the game content is generated by a random
seed; seed corresponds to the game content
  rating, // the player's skill level when playing the record
  record, // corresponding historical record
}
```

As shown, the history record here can store data identifying a game that was played to generate the history record (for example, solitaire, billiards, or other game), a seed used to generate the game content, such as a pseudorandom seed, a players rating, representing an assessed skill level of a player when they played a particular match of the game, and a record storing historical data for the particular match or matches represented. As a simple example, the history record may indicate a total score or other scores achieved while playing the game, while in other examples, data indicating actions, achievements, milestones, or other game outcomes can be associated with the record entry.

One example of a suitable query statement for selecting a history record is shown in Table 5. In this particular example, an SQL query is used to select a record from a collection of history records based on criteria including a game identifier, a seed identifier, and a range of skill ratings. Here the range is expressed as a plus or minus the value “delt” around the rating “user_rating,” but it will be readily understood that other expressions of a range can be used. Using the game and seed identifiers allows for an “apples-to-apples” comparison of historical records. To illustrate, the outcome of a solitaire game can vary widely based on the ordering of cards in the starting deck. The starting deck ordering can be generated based on the seed. By using the seed in the query, the outcome of two solitaire players using the same deck can be performed.

TABLE 5

sql
select record from history_record where game=‘x’ and seed=‘y’
and rating between user_rating − delt and user_rating + delt;

As will be readily understood to a person of ordinary skill in the art having the benefit of the present disclosure, when the number of records in the history_record table is large, there may be two serious performance issues. First, range queries for rating are relatively inefficient and may result in a full table scan. Second, the distribution of historical records by skill level may be very uneven, and there may be many records that match the rating range, such as more than a million, which could overwhelm the database with a single query.

In some examples of the disclosed technology, the performance of rating and player matching can be improved by changing the range query to two-point queries, as discussed in further detail below.

In some examples, the historical records are assigned to groups based on identical or similar values, or “bucketed.” Player ratings, for example, may be bucketed by a step value of 5; within each bucket, the historical records may be consecutively numbered. Then, a skill level bucket dictionary table can be used to look up the historical record numbers. Through the dictionary table, the matching system is used to find the range of historical record numbers, randomly select a specific number, and then use that number to find the specific historical record. An example of a suitable data structure for implementing such a matching system is shown in Table 6:

TABLE 6

```
rating_dictionary
{
  game, // the game
  seed, // the seed generating the game content
  rating_bucket, // skill level bucket number
  record_id_start, // starting number of historical records
in the bucket
  record_id_end, // ending number of historical records in
the bucket
  key (game, seed, rating_bucket) // index
}
### The historical record table is adjusted to:
history_record
{
  game, // the game
  seed, // the seed generating the game content
  rating, // the rating of the player who created the
gameplay record
  rating_bucket, // skill level bucket number
  record_id, // historical record number, either generated
through autoincrement or other methods, which is uniquely
numbered consecutively under a specific game, and a specific
seed, and a specific rating_bucket
  rating_bucket_record, // historical record of a player's
gameplay, including in the form of screen video recording of
the gameplay, or in the form of player's moves (e.g. order of
numbers the player “daubed” in a Bingo game) in a match or a
video replay generated based on such moves, or merely
player's score achieved in a match)
  unique key(game, seed, rating_bucket, record_id) // unique
key index
}
```

As shown above in Table 6, a first data structure outlines a rating dictionary, which includes a game identifier, a seed identifier, a rating bucket identifier indicator, a start and end indicator for indicating the start and end of an ordered collection of buckets associated with the rating dictionary. Further, the data structure can store a key based on the game identifier, seed, and rating bucket indicator.

The second data structure in Table 6 is a different version of a history compared to the history record outlined in Table 4. In Table 6, the history record data structure includes a game identifier, a seed value, a rating of the player that created the record, a rating bucket indicator, a record_id indicating a record in the rating dictionary, a rating_bucket_record, which stores game outcome data for a historical record of the associated historical players game play in a particular match or matches. As an example the rating bucket record can include such data as audio or screen video recording of the associated historical player's gameplay, moves or actions taken by the historical player during the game match (for example, the order of numbers daubed by the player in bingo or the order of cards played by the user in solitaire), a total score or subscores, achievements, or milestones (for example, when clearing a level, obtaining a score on a bonus level, opening a chest or box, etc.). The history record shown further includes a unique key index based on a game identifier, a seed, a rating bucket, and a record id. The unique key index or other suitable unique key identifier can be used to quickly locate an associated history record based on these values.

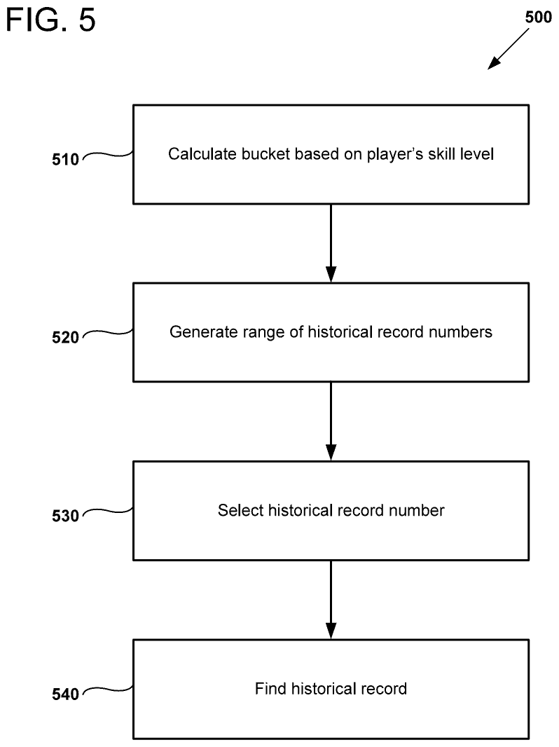

FIG. 5 is a flow chart 500 outlining a method of finding historical records as can be implemented in certain examples of the disclosed technology, including the example networked computing environment discussed above regarding FIG. 1.

At process block 510, a bucket is determined based on an assessment of the player's skill level. The bucket can be associated with a range around a value representing the player's skill level.

At process block 520, a range of historical record numbers is selected from a historical playthrough database. For example, Table 7 shows an SQL database query to obtain record_id start and end values from the rating dictionary described above. The query is based on the game identifier, seed, and the rating bucket determined at process block 510.

TABLE 7

select record_id_start, record_id_end from rating_dictionary
where game=‘x’ and seed=‘y’ and rating_bucket=bucket;

At process block 530, a historical record identifier is selected from the range of historical record numbers. For example, the historical record number can be selected at random from records in the range between record_id_start and record_id_end. As will be readily understood to a person of ordinary skill in the art having the benefit of the present disclosure, other methods can also be used to select a historical record identifier according to the range of record id values.

TABLE 8

selected_record_id = random(record_id_start, record_id_end)

At process block 540, a historical record is found in the historical record table. For example, the database query shown below in Table 9 can be used to select a record from a history record based on a game identifier, a seed, a rating bucket and a record identifier produced at process block 530.

TABLE 9

select record from history_record where game=‘x’ and seed=‘y’
and rating_bucket=bucket and record_id=selected_record_id;

An illustrative example of using a rating dictionary table and a history record table is provided here. An example rating_dictionary table may store sample data as follows:

TABLE 10

| | | | record_{—} | record_{—} |
|---|---|---|---|---|
| game | seed | rating_bucket | id_start | id_end |
| bingo | 291029ad9118ae8b | 300 | 1 | 2 |
| bingo | 291029ad9118ae8b | 301 | 1 | 1 |

An example history_record table may store sample data as shown in Table 11:

TABLE 11

| game | seed | rating | rating_bucket | record_id | record |
|---|---|---|---|---|---|
| bingo | 291029ad9118ae8b | 1500 | 300 | 1 | 1300 |
| bingo | 291029ad9118ae8b | 1503 | 300 | 2 | 1350 |
| bingo | 291029ad9118ae8b | 1508 | 301 | 1 | 1600 |

A player history record can be saved in the history record table. For example, a player, Player A, comes to play the game Bingo with the seed “291029ad9118ae8b”. His skill level is 1504, and the score he achieved is 1360.

After the player submits their scores, this gameplay can be written into the history record table for future matching:
a) The skill level bucket corresponding to the player's skill level of 1500 is calculated as: rating_bucket=1500/5=300;
b) In the rating_dictionary table, the record corresponding to the key (game=“bingo”, seed=“291029ad9118ae8b”, rating_bucket=300) already exists, and the record_id_end is 2. Therefore, the record_id of the newly saved record will be the next auto-incremented number after record_id_end, which is 3. Consequently, the rating_dictionary is updated as shown in Table 12:

TABLE 12

| | | | record_{—} | record_{—} |
|---|---|---|---|---|
| game | Seed | rating_bucket | id_start | id_end |
| bingo | 291029ad9118ae8b | 300 | 1 | 3 |
| bingo | 291029ad9118ae8b | 301 | 1 | 1 |

With record_id=3, the historical record is logged into the history_record table as follows:
INSERT INTO history_record (record_id, player_id, game, seed, skill_level, score)
VALUES (3, ‘Player A’, ‘bingo’, ‘291029ad9118ae8b’, 1504, 1360);

The history_record table is updated as follows:

TABLE 13

| game | seed | rating | rating_bucket | record_id | record |
|---|---|---|---|---|---|
| bingo | 291029ad9118ae8b | 1500 | 300 | 1 | 1300 |
| bingo | 291029ad9118ae8b | 1503 | 300 | 2 | 1350 |
| bingo | 291029ad9118ae8b | 1508 | 301 | 1 | 1600 |
| bingo | 291029ad9118ae8b | 1504 | 300 | 3 | 1360 |

Player B (skill level is 1501) has chosen to play the game Bingo using the seed “291029ad9118ae8b”.

The process for finding historical records to match with Player B in this game is as follows:
a) Calculate the player's skill level bucket: rating_bucket=1500/5=300;
b) In the rating_dictionary table, search for the key (game=“bingo”, seed=“291029ad9118ae8b”, rating_bucket=300), and find record_id_start=1 and record_id_end=3;
c) Randomly select a record_id between 1 and 3, for example, if the randomly selected number is 2, then record_id=2;
d) The result of the search is record=1350. Historical game outcome data can be used to pair the user with a historical playthrough user associated with the selected record resulting from this search.

### V. Example Method of Player Matching

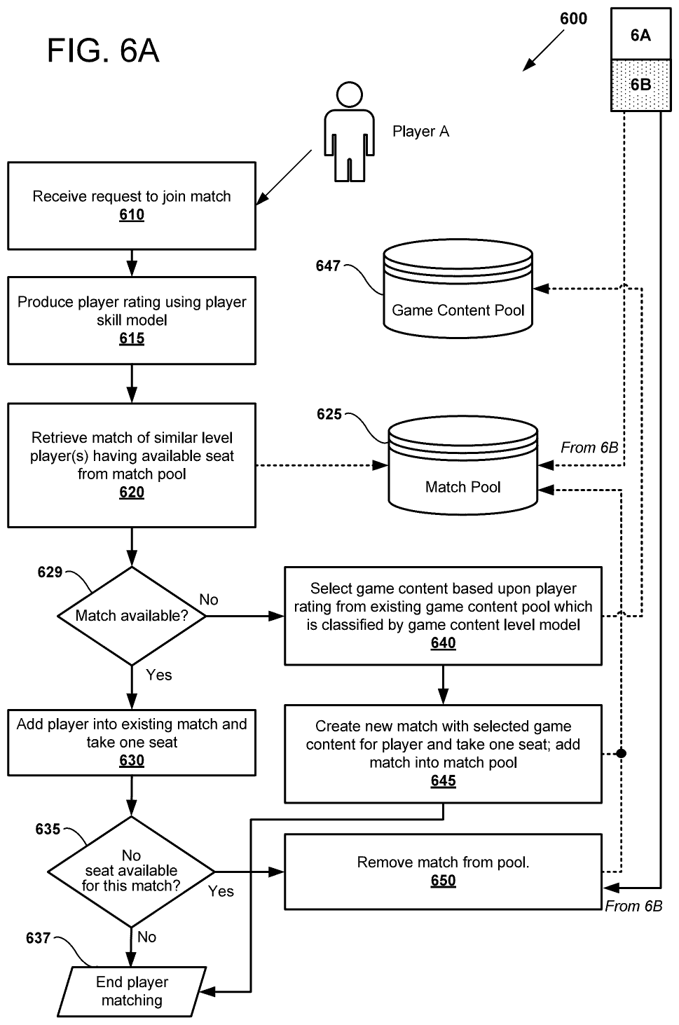

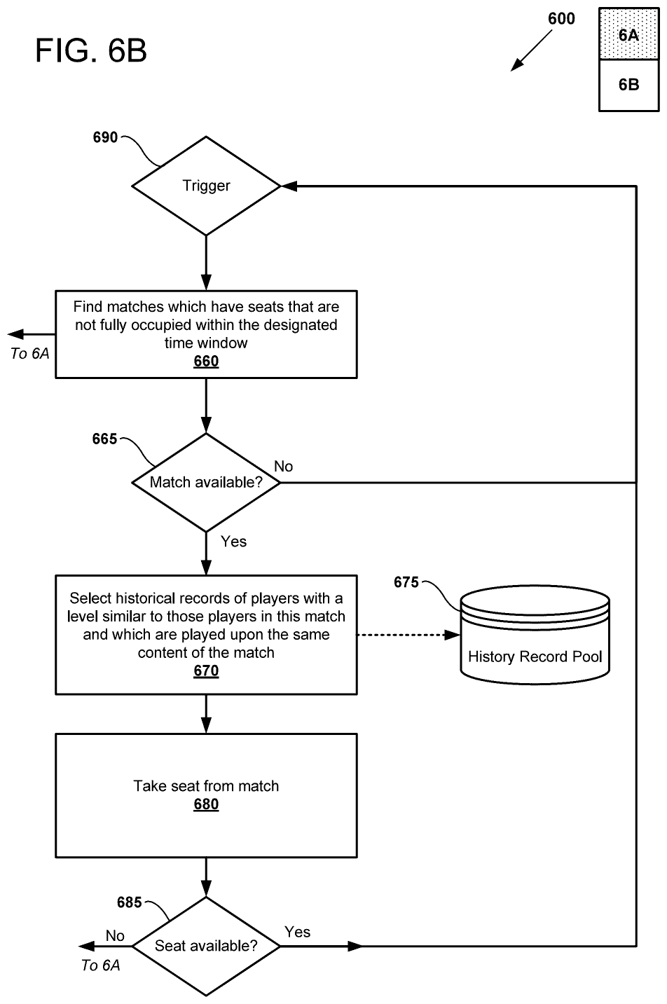

FIGS. 6A and 6B are a flow chart 600 outlining an example player matching (or pairing) process, as can be implemented in certain examples of the disclosed technology. As an example, the networked computing environment described regarding FIG. 1 can be used to implement the matching process of FIGS. 6A-6B.

As shown in FIG. 6A, at process block 610, a request is received to join a match. Responsive to receiving the request, a player rating is produced using a player skill model as disclosed herein at process block 615. The player rating is used to retrieve a match of similar level players which have available seats from the match pool 625 at process block 620. The match pool 625 also stores data for historical playthroughs of previous matches and a match can be selected from the match pool 625 for use with historical playthrough.

At process block 629, it is determined whether a suitable match is available to match for the requesting player A. If a match is available, the method proceeds to process block 630 and the player is added into an existing match and takes a seat in the existing match. If no match is available, then the method proceeds to process block 640.

After process block 630, it is determined whether no seat is available for this match at process block 635. If a seat is available, then the method proceeds to process block 637, and the player matching process ends. On the other hand, if no seat is available for this match, then the method proceeds to process block 650, where the match is removed from the match pool 625.

At process block 640, game content is selected based upon a player rating from the existing game content pool 647, which is classified by a game content level model. The game content can be stored or retrieved from game content pool 647.

At process block 645, a new match is created was selected game content for the player and one seat is taken. This new match is added into the match pool, and the player matching process ends at process block 637.

Turning to FIG. 6B, at process block 660, matches are found for seats that are not fully occupied within a designated time window. At process block 665, it is determined whether a match is available. If a match is available, then the method proceeds to process block 670, otherwise, the process proceeds to process block 690 to wait until a triggering event is received. For example, the addition of live players, removal of live players, player action selecting a game or match, or other events can cause a triggering event to be received. After the trigger is received, the process proceeds to process block 660.

At process block 670, historical records of players with a level similar to those players in the current match and which are played upon the same content of the match are selected. The history record pool 675 is updated accordingly, and the method proceeds to process block 680 where a seat is taken from the match. If it is determined at process block 685 that a seat is available, then the method proceeds to process block 690. As stated in the preceding paragraph, the addition of live players, removal of live players, player action selecting a game or match, or other events can cause a triggering event to be received. After the trigger is executed, the method proceeds to process block 660 where matches are found for seats that are not fully occupied within a designated time window. If no seat is available, the method proceeds to process block 650, and the match is removed from the pool.

### VI. Example of Historical Playthrough Display

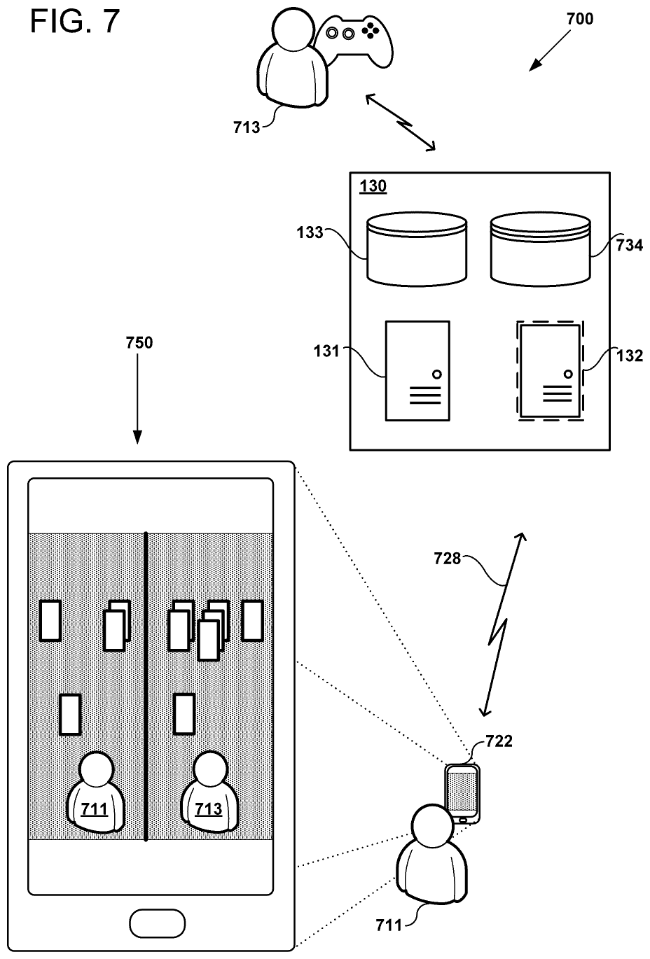

FIG. 7 is a diagram 700 outlining an example of historical playthrough as can be implemented in certain examples of the disclosed technology. As shown, a player user 711 is using a computing device 722 having a network connection 728 to the dedicated networked server 130 discussed above regarding FIG. 1. The network server determines that there are no suitable real-time players available in the environment for the online game indicated by the player user 711. Accordingly, a historical game playthrough is selected in the historical playthrough server 734 using any of the methods disclosed herein. Here, a previous match for a previous player 713 is selected as the opponent. A simulated real-time competition is then performed, with the player user 711 competing against the opponent. As shown, the computing device 722 can simultaneously display 750 the player user 711 game alongside the historical playthrough from the opponent. Such a display 750 can provide the user player with the experience of competing against a human player in real-time.

### VII. Example of Providing Online Game Including a Historical Playthrough Opponent

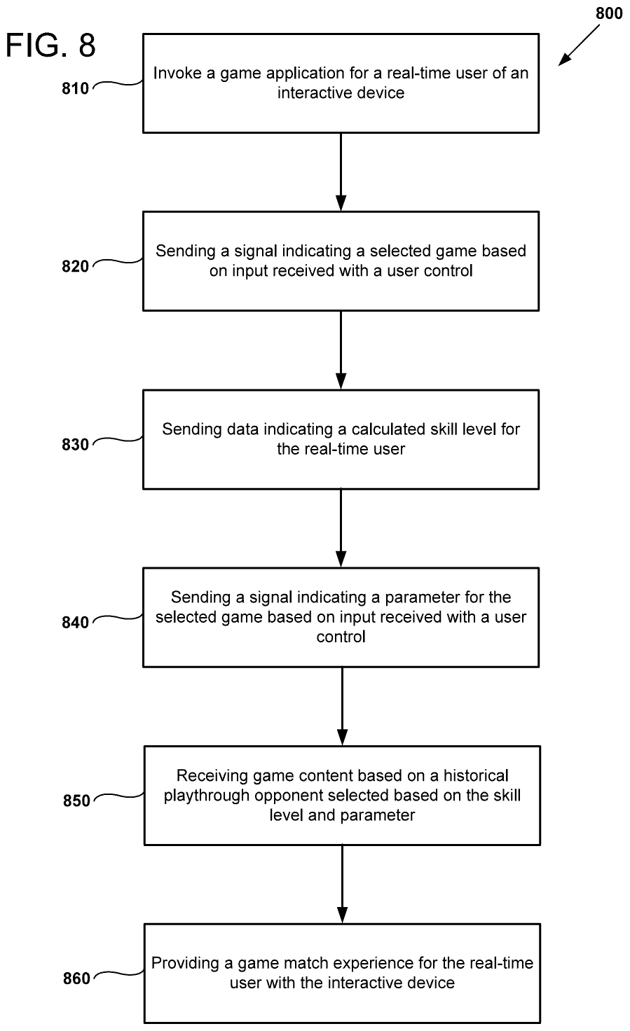

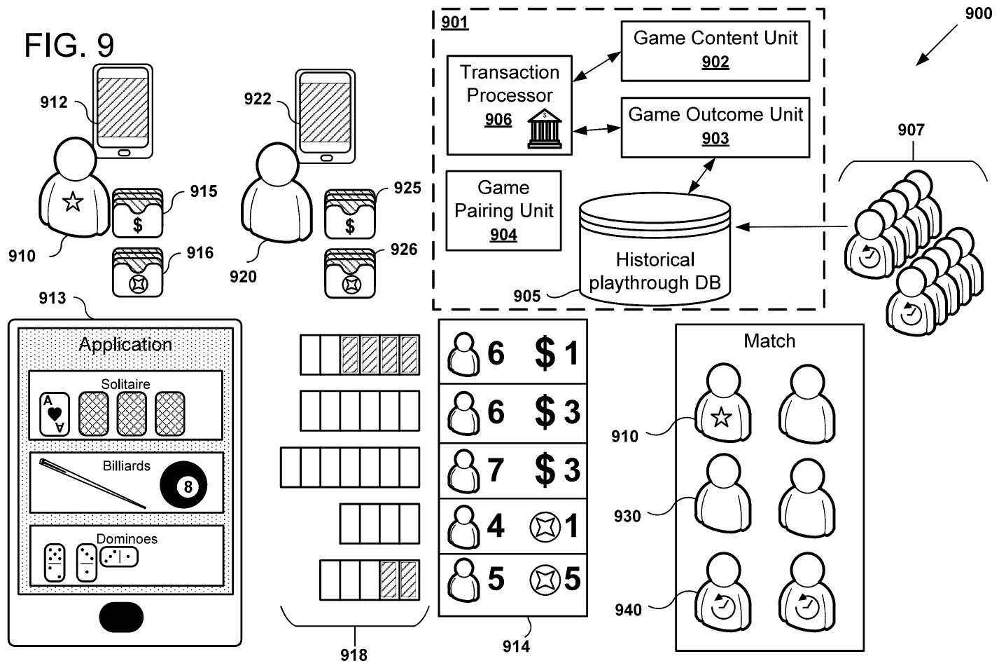

FIG. 8 is a diagram 800 outlining an example method of providing an online game including a historical playthrough opponent, as can be implemented in certain examples of the disclosed technology. A specific example of an environment in which such an example method can be performed is provided with reference to the diagram 900 of FIG. 9. FIG. 9 includes an online game server 901, which includes a processor, memory, storage, and a network interface that can be used to implement the associated components or interfaces to associated component provided by a different computing system by providing communication to other networked components, devices, computers, or systems. As shown, the online game server 901 includes a game content unit 902, which provides game content to users, and a game outcome unit 903, which calculates data describing game outcomes including scores, milestones and/or actions made by players during a game, and a game pairing unit 904, which is used to pair a current real-time user with other real-time users or historical playthrough users. The online game server 901 can further include a historical playthrough database 905, which is a database described in further detail herein that stores records for game outcomes from historical playthrough users, and a transaction processor 906 which is used to process entry fees and prizes from games as cash, bonus cash, and/or tokens. The historical playthrough database 905 can receive game outcome data from a current real time user or a number of historical playthrough users 907, which can use the same or a different game outcome unit to provide game outcome data. There can be data for hundreds, thousands, millions, or more historical playthrough users and associated matches.

At process block 810, a game application is invoked for a real-time user of an interactive device. For example, an application can be launched on a mobile device, laptop computer, game console, or other suitable device. The application can be in communication with an online game server 901 that provides functionality including player rating, game content for historical playthrough, a database 905 that can be used for historical playthrough record searching and retrieval, player pairing, entry fee and prize transaction processing, game content, scoring, and other suitable functionality disclosed herein. The online game server 901 can be in communication with one, two, or more real-time players. For example, as shown in FIG. 9, a real-time user 910 is indicated by a star. The real-time user uses an interactive device 912; as depicted in this example, the interactive device is a mobile device such as a smartphone or tablet. The real-time user 910 has access to digital wallets 915, 916 that store records indicating cash or game tokens, respectively, that the user can use for entry fees to games on the online server. In some examples, the cash is added to the digital wallet by an electronic bank transaction (for example, an ACH transaction as in the United States, or other suitable electronic funds transfer method) or a credit card transaction. In some examples, the cash added to the wallet can include bonus cash or other cash that can be used to pay entry fees for games, but cannot be transferred from the digital wallet. The tokens in the digital wallet 916 may be obtained by promotions, by winning other matches of the same game or by winning other games. Also shown is another real-time user 920 who can use an associated interactive device 922, cash wallet 925, and token wallet 926 in a similar fashion as the real-time user 910. As will be readily understood, other types of accounts storing currency than digital wallets may also be employed. The other real-time user 920 can be an opponent or a collaborator with the real-time user in certain examples. The real-time users 910 and 920 can be paired by a game pairing unit 904 of the online game server 901 after invoking an application and providing sufficient game indications, game parameters, and data to calculate user skill levels.

At process block 820, based on input from user input control, the interactive device used by the real-time user transmits a signal to the online game server 901 indicating a selected game of a plurality of games to provide with the game application. For example, as shown in FIG. 9, an enlarged depiction of the display 913 of the interactive device 912 is shown. As shown, the real-time user 910 is provided with three games to choose from: a solitaire card game, a billiards game, and a dominoes game. User control input can be received from the display 913 when it is a touch screen, or other input such as buttons, keyboards, motion, voice, or other suitable input can be used to select a game.

At process block 830, data is sent to the online game server 901 to calculate a skill level for the real-time user. For example, data for a game outcome, such as a score, whether particular events or milestones were achieved (for example, for use in identifying high-level player actions), time to complete actions or tasks, reaction time, difficulty settings, or other suitable data can be sent. In some examples, at least some, or all, of the data is generated at the online game server (for example, calculation of a game score). For example, as shown in FIG. 9, score, game events, or other achievements can be transmitted to an online game server 901 and used by a game pairing unit 904 to calculate skill levels and pair users using the historical playthrough database 905.

At process block 840, a signal is sent to the online game server 901 indicating at least one parameter for an online match session of the game selected at process block 820. For example, parameters such as difficulty, number of opponents, entry fee, or other suitable parameters for the game can be indicated by a signal sent by the interactive device to the game pairing unit 904. As shown in FIG. 9, the display 914 of the real-time user interactive device 912 has been updated to show available game matches according to the at least one parameter. As shown, the display 914 depicts five matches to choose from, including the total number of players (from top to bottom, matches with 6, 7, 8, 4, and 5 total players) and associated entry fees (from top to bottom, $1, $3, $3, 1 token, 5 tokens). Other parameters can also be displayed, for example, the total amount of prize money available to all participants or the top participant after the match is concluded. User control input, such as touchscreen display input or other input from devices or microphones can be used to select one of the matches.

FIG. 9 also illustrates a number of queues 918 associated with each match. As shown, four real-time players are queued for the first match (6 players, $1 entry fee) and two players are queued for the last match (5 players, token entry fee). Based on various pre-defined criteria, the online game server 901 can determine to initiate a match even if a queue is not filled with real-time users. In such cases, one or more historical playthrough users are provided to simulate play as if they were real-time users. The criteria used to determine whether to start the match can include, for example, waiting time or forecasted numbers of available real-time players.

At process block 850, game content is retrieved from the game content unit 902 by the online game server 901 based on a historical playthrough opponent that is selected by the online game server. For example, the opponent can be selected based on the selected game indicated by the interactive device, by the parameters sent by the interactive device, or other suitable data which is used to assess a skill level of the real-time user a generate pairings with a historical playthrough opponent. Game content is generated based on the selected opponent(s) and at least some of the game content can be generated prior to invoking the game application or sending the signals to the server for the interactive device. The game outcome data can include scores, prior actions taken by the historical player, such as historical playthrough users 907, game configuration, game seeds used to initiate a game match, or other suitable data.

At process block 860, the interactive device provides a game match experience to the real-time users and optionally historical playthrough users with a game application. The game application can use data from user input controls coupled to the interactive device (for example, a touch screen display, microphone, motion sensing, camera, or other suitable game input) and output displayed to the real-time user (for example, using a display or touch screen display, audio output, haptic feedback, or other suitable output). As shown in FIG. 9, this particular match has the current real-time user 910, three other real-time users (for example, another real-time user 930), and two historical playthrough users (for example, another real-time users 940).

### VIII. Example Computing Environment

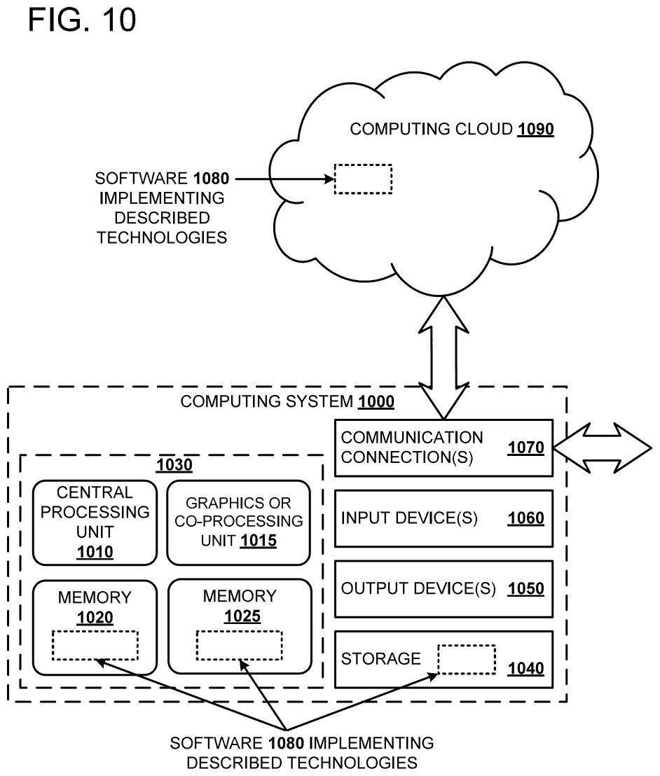

FIG. 10 depicts a generalized example of a suitable computing system 1000 in which embodiments, techniques, and technologies can be implemented. The computing system 1000 is not intended to suggest any limitation as to scope of use or functionality, as the innovations may be implemented in diverse general-purpose or special-purpose computing systems. For example, the disclosed technology may be implemented with other computer system configurations, including handheld devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions) may be located in both local and remote memory storage devices. By way of further example, the computing system 1000 can be used to implement disclosed games or other applications, online game servers, databases, and to provide interactive controls disclosed herein.

With reference to FIG. 10, the computing system 1000 includes one or more processing units 1010, 1015 and memory 1020, 1025. In FIG. 10, this basic configuration 1030 is included within a dashed line. The processing units 1010, 1015 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s).

A computing system may have additional features. For example, the computing system 1000 includes storage 1040, one or more input devices 1050, one or more output devices 1060, and one or more communication connections 1070. An interconnection mechanism (not shown) such as a bus, controller, or network interconnects the components of the computing system 1000. Typically, operating system software (not shown) provides an operating environment for other software executing in the computing system 1000, and coordinates activities of the components of the computing system 1000.

The tangible storage 1040 may be removable or non-removable, and includes magnetic disks, magnetic tapes or cassettes, CD-ROMs, DVDs, or any other medium which can be used to store data and which can be accessed within the computing system 1000. The storage 1040 stores instructions for the software 1080 implementing one or more innovations described herein.

The input device(s) 1050 may be a touch input device such as a keyboard, mouse, pen, or trackball, a voice input device, a scanning device, or another device that provides input to the computing system 1000. For video encoding, the input device(s) 1050 may be a camera, video card, TV tuner card, or similar device that accepts video input in analog or digital form, or a CD-ROM or CD-RW that reads video samples into the computing system 1000. The output device(s) 1060 may be a display, printer, speaker, CD-writer, or another device that provides output from the computing system 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system. In general, a computing system or computing device can be local or distributed, and can include any combination of special-purpose hardware and/or general-purpose hardware with software implementing the functionality described herein.

Some embodiments of the disclosed methods can be performed using computer-executable instructions implementing all or a portion of the disclosed technology in a computing cloud 1090. For example, disclosed servers are located in the computing environment, or the disclosed applications can be executed on servers located in the computing cloud 1090. In some examples, the disclosed applications execute on traditional central processing units (e.g., RISC or CISC processors).

Computer-readable media are any available media that can be accessed within a computing system 1000 environment. By way of example, and not limitation, with the computing system 1000 environment, computer-readable media include memory 1020 and/or storage 1040. Computer-readable memory can store data and computer-readable instructions that when executed by one or more of the processing units 1010, 1015, cause the computing system 1000 to perform one or more methods disclosed herein for pairing users, providing game applications, and so on. As should be readily understood, the term computer-readable storage media includes the media for data storage such as memory 1020 and storage 1040, and not transmission media such as modulated data signals.

In view of the many possible embodiments to which the principles of the disclosed invention may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

What is claimed is:

1. A system comprising:
a processor;
a network interface coupled to the processor and a computer network; and
computer-readable storage media storing computer-readable instructions that when executed by the processor, cause the system to perform a method, the computer-readable instructions comprising:
instructions that cause the system to produce a real-time user rating by ranking a prior game outcome for a match previously played by a real-time user of a computer-implemented game relative to game outcomes for previous matches of the computer-implemented game previously played by other players under similar or identical game initiation conditions;
instructions that cause the system to pair at least one other user with the real-time user based on the real-time user rating and game actions or game outcomes produced by the at least one other user; and
instructions that cause the system to initiate a match with the real-time user and the paired at least one other user.

2. The system of claim 1, wherein the at least one other user is a historical playthrough user; and
the computer-readable instructions further comprise instructions to that cause the system to provide game content to the real-time user during the match based on game actions or game outcomes that were generated by the paired at least one other user prior to the system initiating the match.

3. The system of claim 1, wherein the at least one other user is a live user; and
the computer-readable instructions further comprise instructions that cause the system to provide game content to the real-time user based on game actions or game outcomes concurrently generated by the at least one other user during the match.

4. The system of claim 1, wherein the computer-readable instructions further comprise:
instructions that cause the system to produce a rating for at least one other user by ranking a prior game outcome for a match previously played by the at least one other user relative to game outcomes for matches previously played by other players under similar or identical game conditions, thereby producing a rating for the other user, and
wherein the instructions that cause the system to select the at least one other user comprise instructions to compare the real-time user rating and the rating for the at least one other user.

5. The system of claim 1, wherein the computer-implemented game is a competitive online game, and wherein the instructions that cause the system to select the paired users further comprise:
instructions that cause the system to produce a player base rating representing a base skill level of a player of a competitive online game;
instructions that cause the system to produce a player high rating representing a high skill level of the player; and
instructions that cause the system to, based on the player base rating and the player high rating, select the paired users for the competitive online game.

6. The system of claim 5, wherein the base skill level is produced using at least one of: a player's rating before a current match of the competitive online game, an actual result of a match of the competitive online game, an expected result of a match of the competitive online game, a predetermined factor, or a skill rating of an opponent.

7. The system of claim 5, wherein the high skill level is produced using at least one of: a player's rating before a current match of the competitive online game, an actual result of a match of the competitive online game, an expected result of a match of the competitive online game, a predetermined factor, or a skill rating of an opponent.

8. The system of claim 5, wherein at least one of the base skill level or the high skill level is produced using a percentile rank of historical records for prior matches of the competitive online game.

9. The system of claim 5, wherein the real time user and the paired at least one other user each play in the same match using at least some of the same game content, the game content being generated using at least one random seed or starting conditions for a designed level.

10. The system of claim 5, further comprising instructions that cause the processor to assess the skill level of the at least one real-time user, the at least one other user, or a historical playthrough user based on a segmented assessment combining a base rating and high-ability rating for each respective assessed user.

11. The system of claim 10, wherein the instructions that cause the processor to assess the skill level comprise:
instructions that cause the processor to generate the base rating by determining a percentile rank of at least one game outcome for the respective assessed user in a set of game outcomes.

12. The system of claim 11, wherein the instructions that cause the processor to assess the skill level comprise:
instructions that cause the processor to generate the high-ability rating by assessing whether a game outcome for the respective assessed user exceeds a pre-determined threshold.

13. The system of claim 12, wherein the instructions that cause the processor to select the paired users comprise:
instructions that cause the processor to generate a user rating based on a nonlinear weighting of the base rating and the high-ability rating.

14. The system of claim 1, further comprising:
instructions that cause the processor to identify a user record stored in a cache, the cache storing game outcome records for the at least one other user, the user record being identified in a leaderboard cache according to a key index and a range of player ratings; and
instructions that cause the system to select at least one of the paired users as a user associated with the identified user record.

15. The system of claim 14, wherein the key index is based on a seed used to generate content for application, wherein the same content is generated for the application when the same seed is used to generate content, and different content is generated for the application when a different seed is used to generate content.

16. A method comprising:
with a device comprising a processor coupled to a user input control, a display, and a network interface configured to be in communication with an online game server:
with the processor, invoking an application executed using the processor to provide an online game session for a game to a real-time user of the device;
based on input from the user input control sending a signal indicating at least one game parameter for the online game session via the network interface sending data to the online game server used to calculate a skill level for the real-time user;
responsive to the sending the signal, receiving game content produced by the online game server based on a historical playthrough opponent that is selected by the online game server based on the skill level, the at least one parameter, or the skill level and the at least one parameter, the game content being generated based on a game outcome of a match played by the historical playthrough opponent, the game outcome being generated based on interaction with a real-time user prior to the invoking the application or prior to the sending the signal indicating the at least one game parameter; and
with the application, providing a game match experience to the real-time user with the user input control and the display based on the received game content.

17. The method of claim 16, further comprising:
presenting a user input control to the real-time user allowing the game to be selected from a plurality of games available using the application; and
sending a signal indicating the selected game of a plurality of games to provide with the game application via the network interface, wherein:
the game content is generated responsive to the online game server receiving the signal via the network interface.

18. The method of claim 16, further comprising:
with the device, receiving an indicator of an entry fee from a digital wallet associated with the user, the at least one parameter comprising the entry fee; and
depending on an outcome of the game match, distributing a prize to the digital wallet or transferring the entry fee to another account identified by the online game server.

19. The method of claim 16, wherein the game match experience comprises at least one of head-to-head play against another live player or asynchronous play based on the game outcome generated by the historical playthrough opponent.

20. Computer-readable storage media storing computer-readable instructions, which when executed by a processor, cause the processor to perform a method, the instructions comprising:
instructions that cause the processor to determine a bucket of a plurality of buckets of historical records of previous sessions of online gameplay, the plurality of buckets being accessible from a database, the determined bucket based on a skill level of a real-time player of a competitive online game;
instructions that cause the processor to produce at least one of the historical records from the database based on the determined bucket; and
instructions that cause the processor to initiate an online game match among plural users, the plural users comprising the real-time player and a historical playthrough user identified based on the at least one of the produced historical records.

21. The computer-readable storage media of claim 20, wherein the instructions that cause the processor to produce the at least one of the historical records selects the produced at least one of the historical records based on at least one selected from the group consisting of: a game identifier, a seed used to generate game content provided during the online gameplay, an identifier of the determined bucket, an identifier of a starting historical record in the determined bucket, and an identifier of an ending historical record in the determined bucket.

22. The computer-readable storage media of claim 21, wherein the instructions further comprise instructions that cause the processor to host a match of a competitive online game including the real-time player and the historical playthrough user determined using the at least one of the produced historical records.

23. The computer-readable storage media of claim 20, wherein the instructions further comprise instructions that cause the processor to generate and store a historical record in the database including a data structure comprising a game identifier, a seed used to generate game content provided during the online gameplay, an identifier of a rating bucket, a record identifier generated consecutively based on the game identifier, the seed, and the rating bucket identifier, history data for the historical record, and a unique key identifier based on the game identifier, the seed, the rating bucket identifier, and the record identifier.
